(19) United States
(12) Patent Application Publication
(10) Pub. No.: US 2017/0330286 A1
(43) Pub. Date: Nov. 16, 2017

(54) Convenience Store Sales Tax Calculator

(71) Applicant: Daniel Martinez, JR., Richmond, TX (US)

(72) Inventor: Daniel Martinez, JR., Richmond, TX (US)

(21) Appl. No.: 15/152,353

(22) Filed: May 11, 2016

(51) Int. Cl. G06Q 40/00

(52) U.S. Cl. CPC G06Q 40/10

(57) ABSTRACT

A web-based software application accessible by subscribers via the internet at: http://cstore.saltwaretax.com, which allows convenience store and similar retail store owners to calculate Texas sales and use taxes by entering their purchases manually or by importing records electronically. The application connects to a database named “Cstore” which stores taxability decisions for convenience store products and expenses and is used by the application to calculate the sales tax payable. The subscriber may also upload digital images of transaction invoices to be stored electronically for future reference.

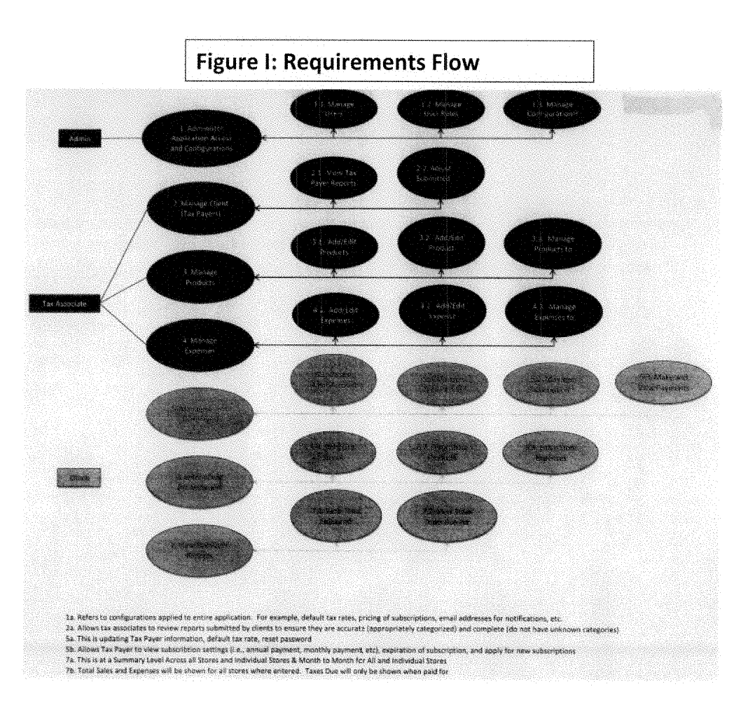

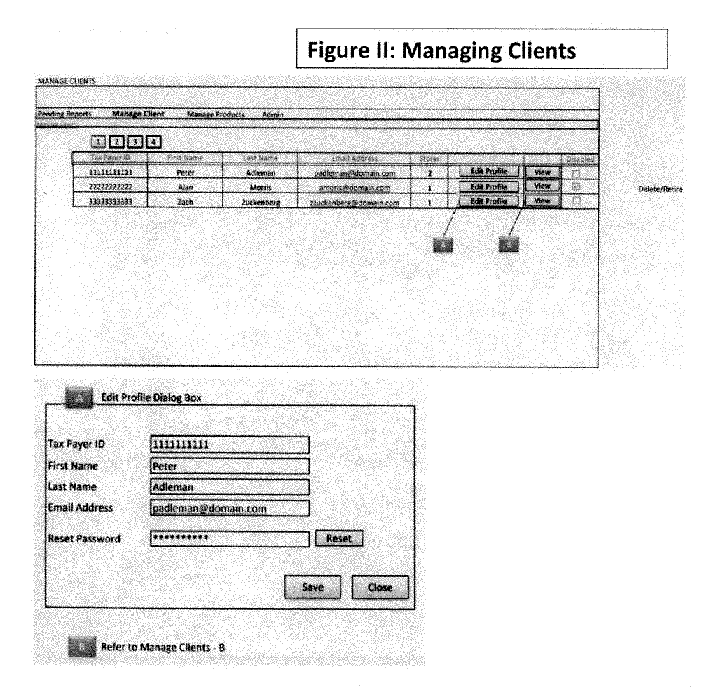

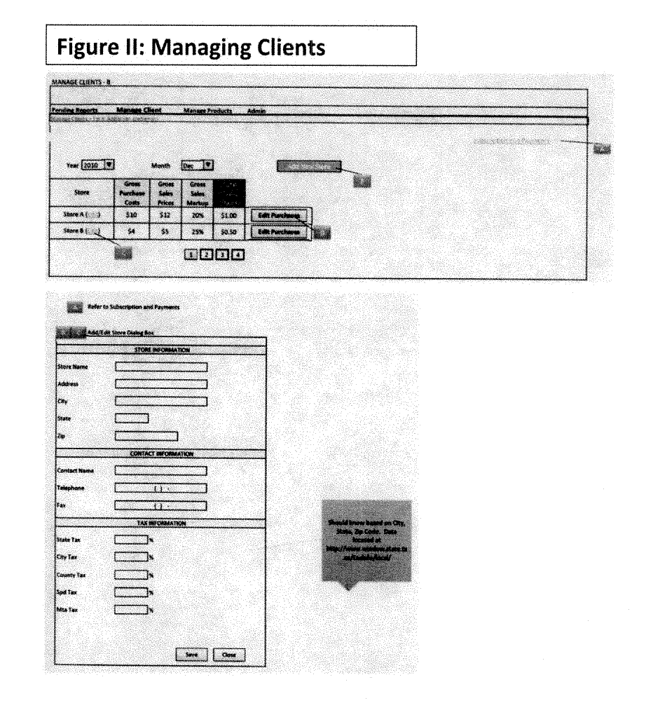

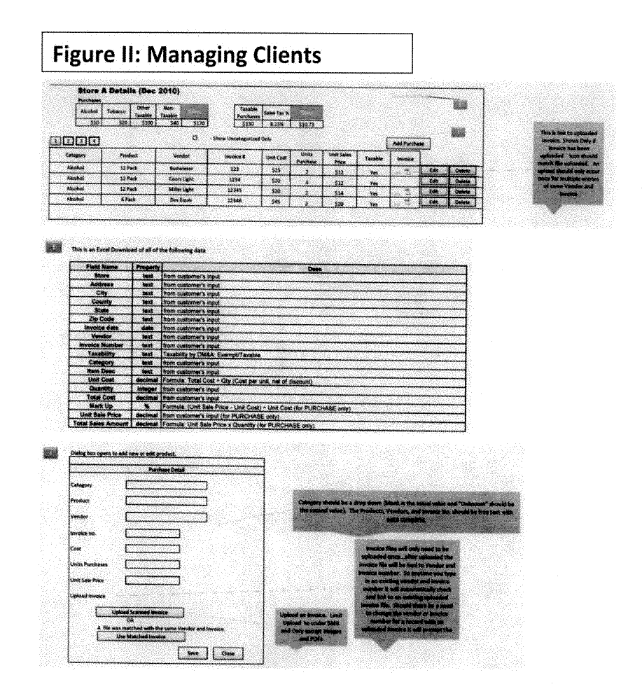

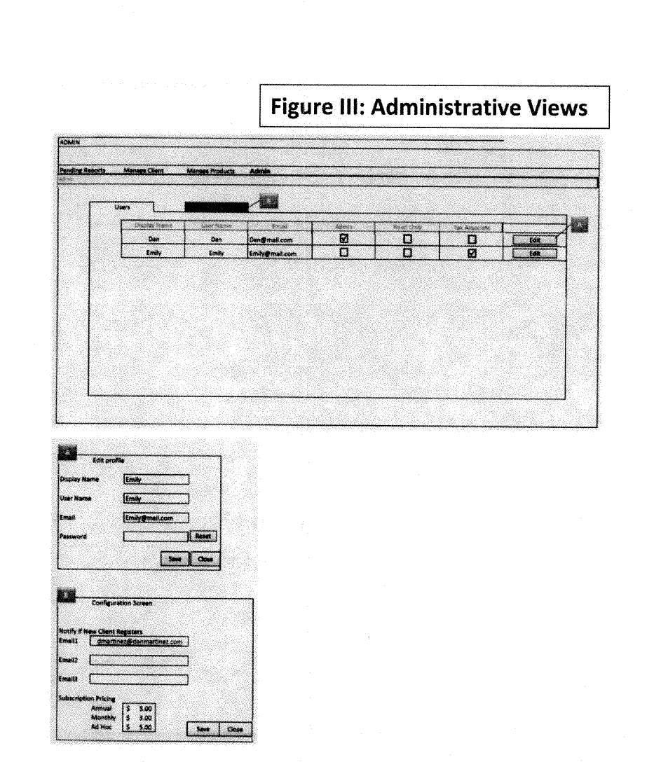

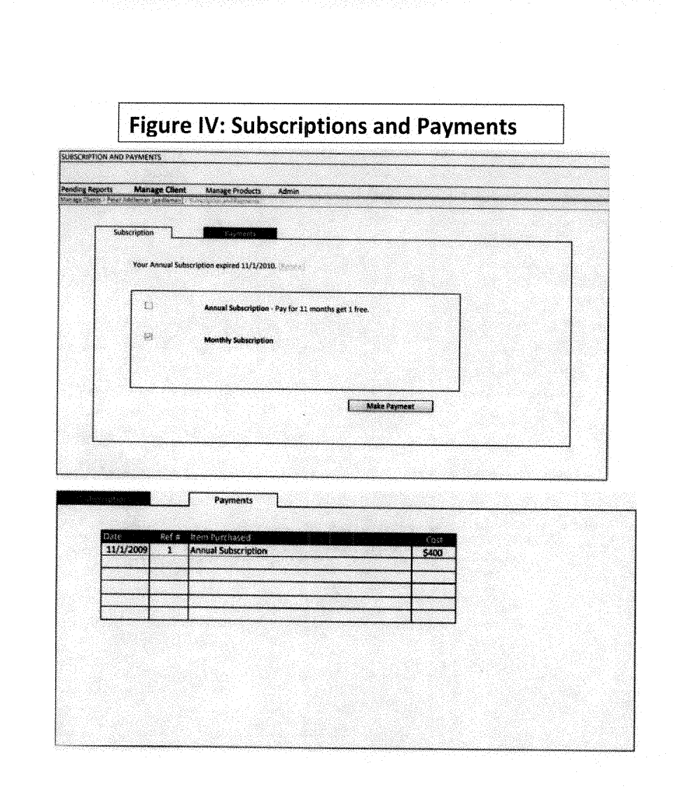

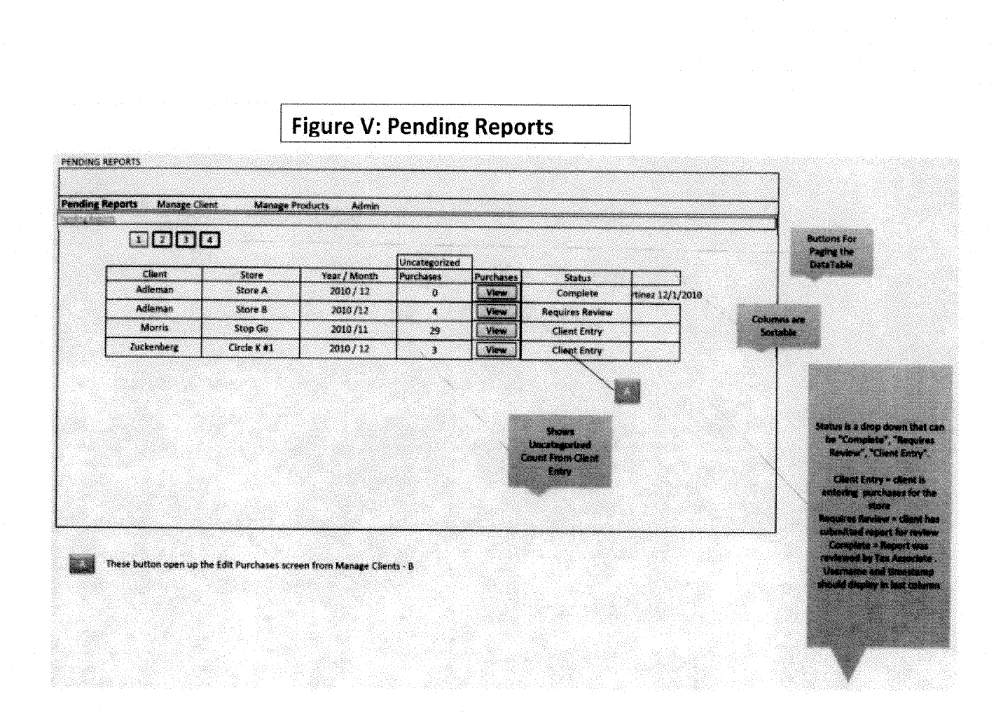

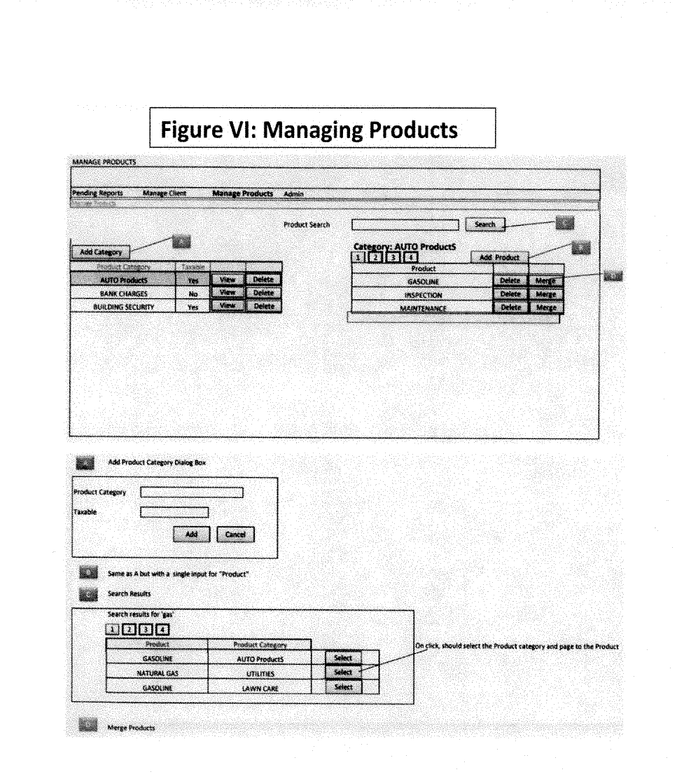

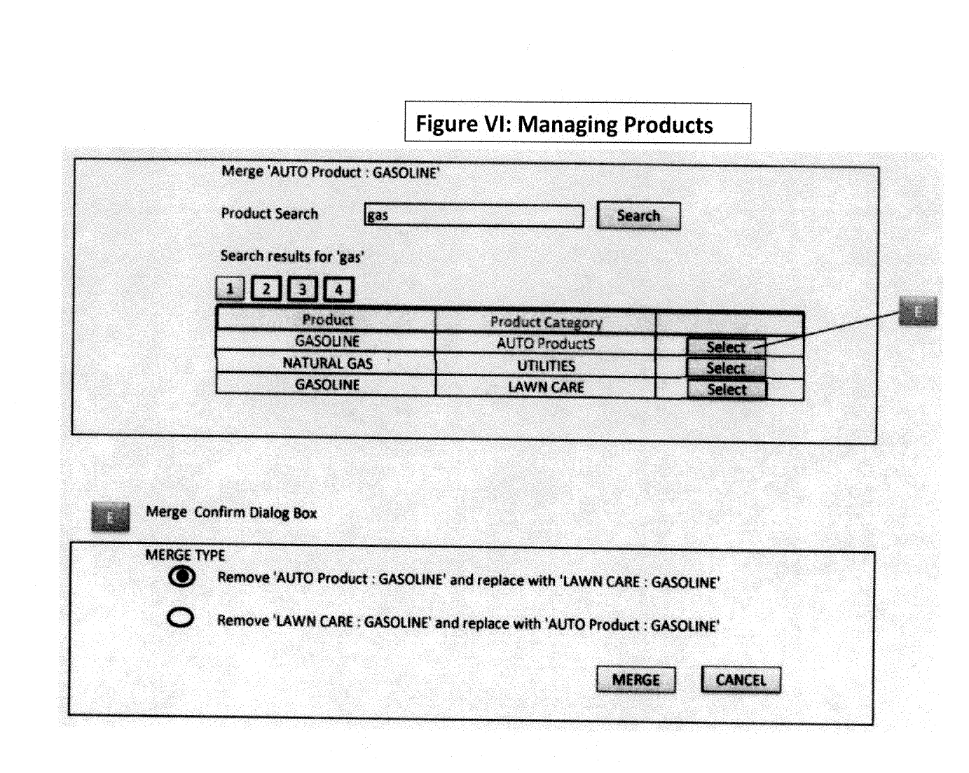

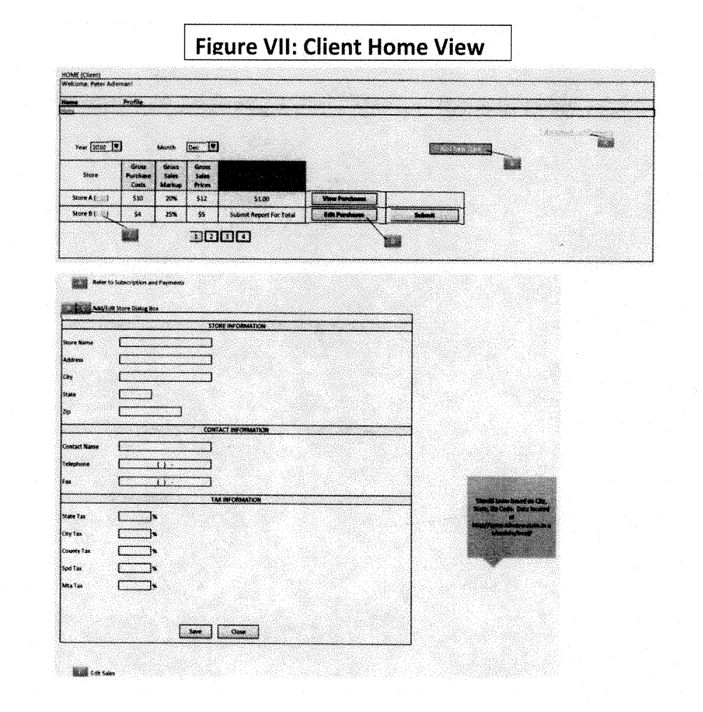

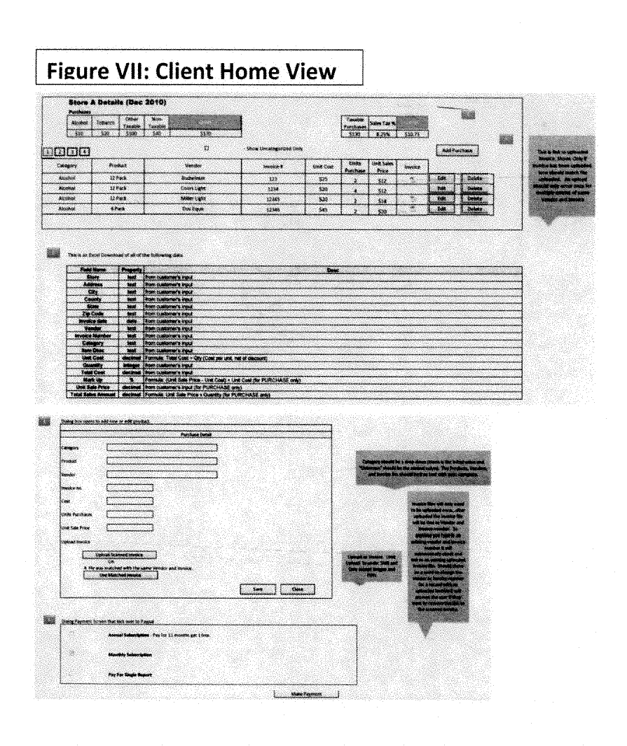

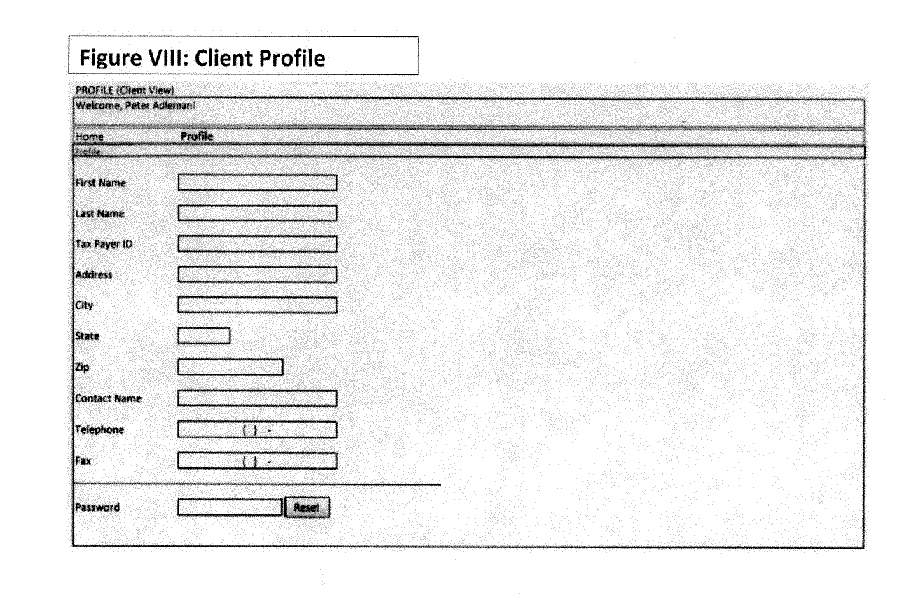

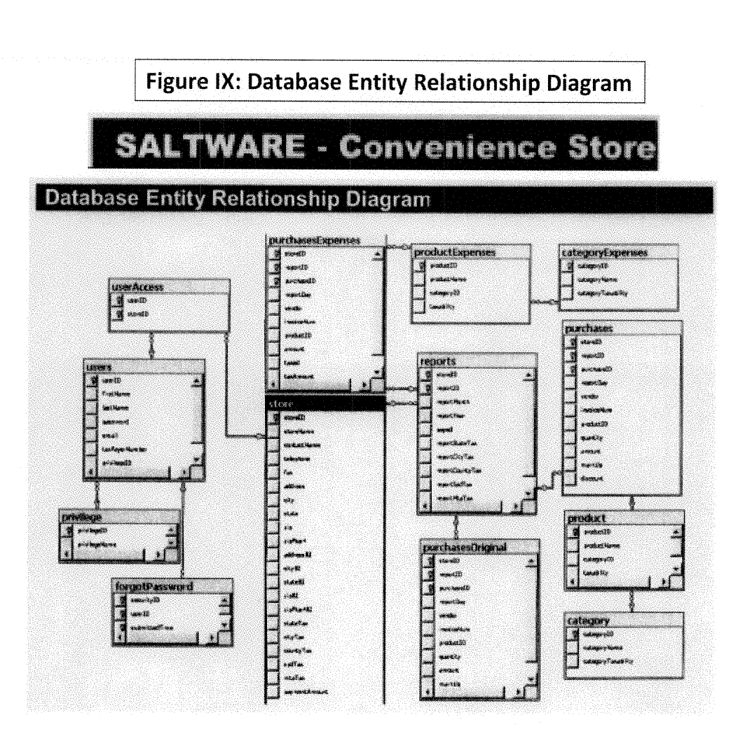

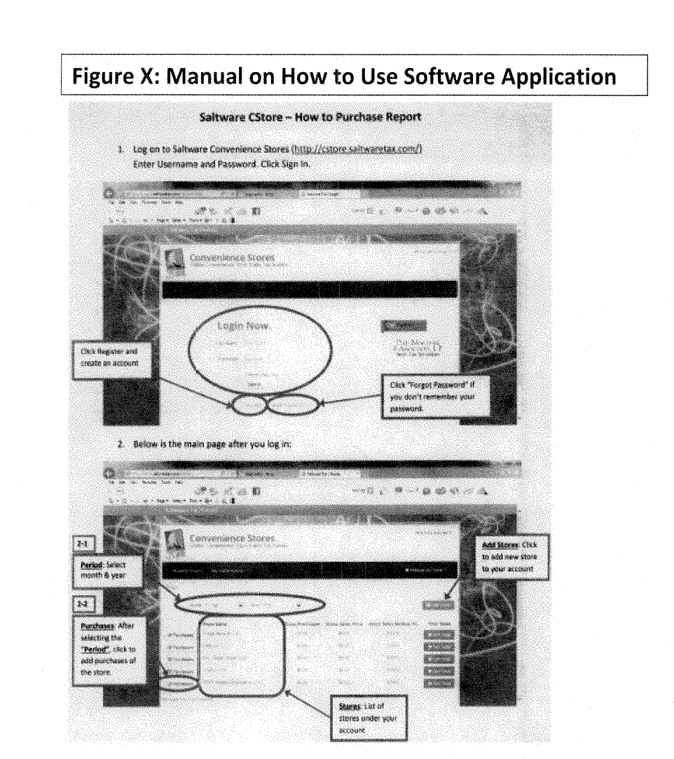

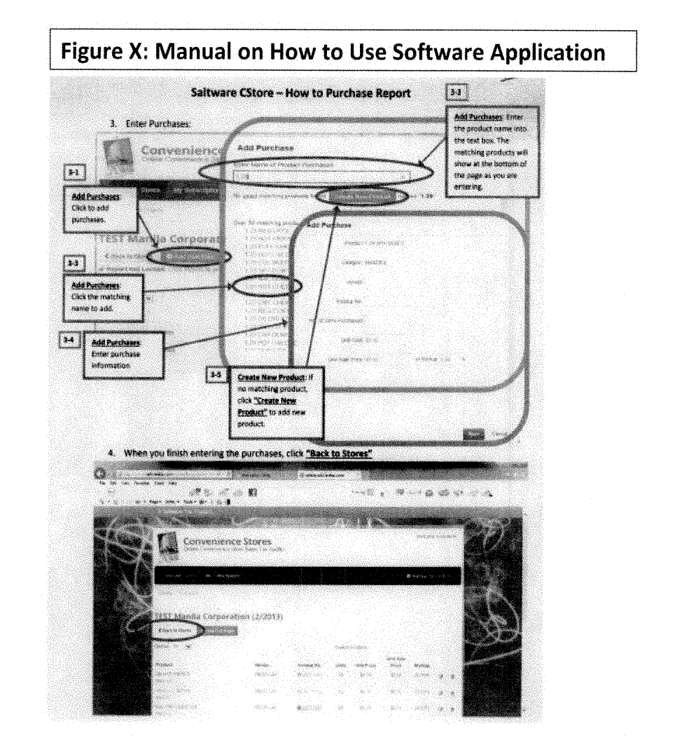

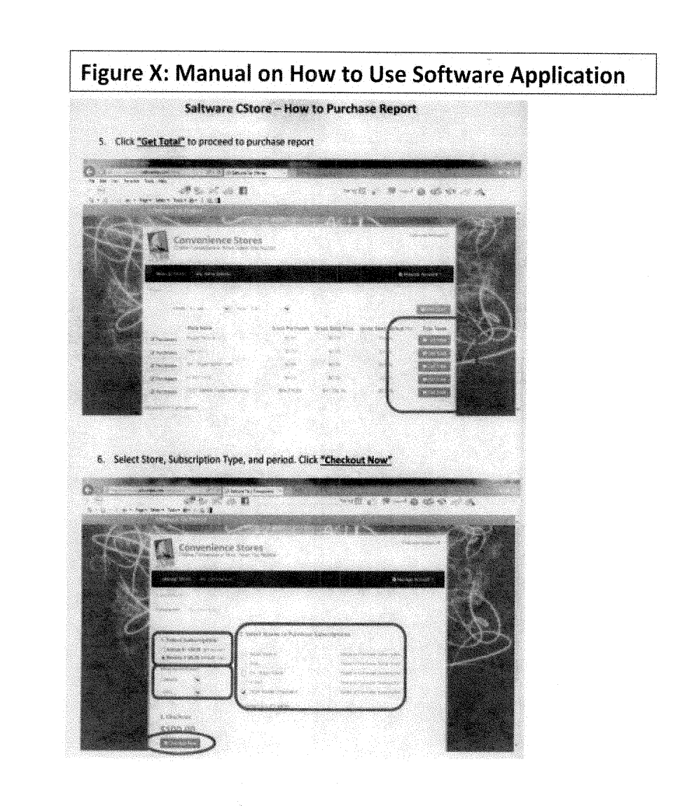

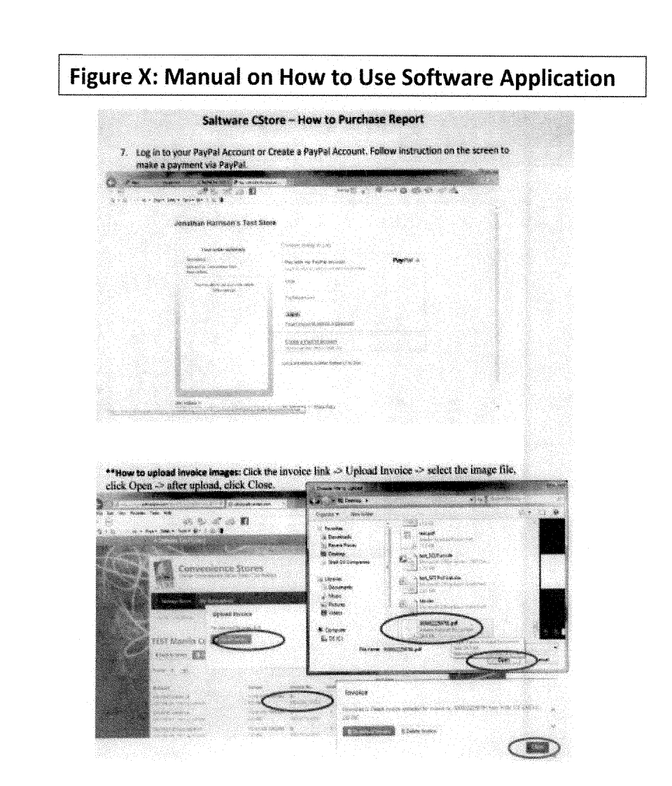

### CROSS REFERENCE TO RELATED APPLICATIONS

Utility Provisional Patent Application 62/122,655 filed Oct. 27, 2014

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Passed during the 80th Legislative Session in 2007, HB 11 dramatically increased the Comptroller's ability to identify, audit and, when appropriate, prosecute retailers who are collecting sales tax but not remitting the proper amount to the state.

HB 11 amended the Alcoholic Beverage Code and the Tax Code to require distributors and wholesalers who make sales of ale, beer, wine, cigarettes, cigars and tobacco products to Texas retailers to report those sales monthly to the Comptroller's office. Those distributors and wholesalers are also required now to report that data electronically, unless inability to do so is shown.

HB 11 data, which has now been collected since January 2008, allows the Comptroller to compare the purchases that retailers have made of these products with the sales that retailers are required to report. Because both sets of data are largely received electronically, discrepancies can be more easily and rapidly identified. Rapid identification is essential so that the Comptroller auditors can begin their work to mitigate and recoup the revenue loss to the state. Since fiscal 2009, the Comptroller's office has identified more than $523 million due to the state.

In some cases, audit documentation may suggest that the taxpayer had criminal intent to evade taxes. If so, the case will be reviewed and evaluated by the Criminal Investigations Division for the possible filing of criminal charges.

In the event a retailer like a convenience store fails to maintain adequate records, the auditor will estimate sales and use taxes payable based on the purchase data collected from the convenience store's retailers under HB 11. That is, the auditor will estimate a markup on such purchase data and then estimate sales tax due based upon such marked up values. Use of these estimates lead to higher audit assessments at the grave expense of the convenience store. We have defended several convenience stores in the Houston area that have been audited under HB 11 and have found that the best way to protect convenience stores from increased sales taxes is to eliminate the use of estimates, which can only be accomplished by keeping good records. To assist in recordkeeping and estimation of sales tax payable, we have developed the Convenience Store Sales Tax Calculator.

### FIELD OF THE INVENTION

The present invention relates to systems and methods for calculating sales tax. In particular, the present invention relates to a web application for computation of sales tax.

### BRIEF SUMMARY OF THE INVENTION

The present invention is a web based software application that allows those responsible for paying convenience store sales and use taxes to easily submit their sales and expenses online and obtain a calculation of sales tax payable.

### BRIEF DESCRIPTION OF THE SEVERAL VIEWS OF THE DRAWING

Figure I: Requirements Flow

Figure II: Screen Shots Regarding Managing Clients

Figure III: Screen Shots Illustrating Administrative Views

Figure IV: Screen Shots Illustrating Subscriptions and Payments

Figure V: Screen Shot Illustrating Pending Reports

Figure VI: Screen Shots Illustrating Managing Products

Figure VII: Screen Shots Illustrating Client Home View

Figure VIII: Screen Shot Illustrating Client Profile View

Figure IX: Database Entity Relationship Diagram

Figure X: Manual on How to Use Software Application

### DETAILED DESCRIPTION OF THE INVENTION

The present invention relates to a software for handling and automating the calculation of sales and use tax payable by convenience stores. The software application is web based and may be accessed by convenience store taxpayers on their own hardware via the internet at http://www.saltwaretax.com/cstore. Convenience store taxpayers may register (and thereafter login) on the previously referenced website as shown in Figure X. The taxpayer will then enter profile information (i.e. taxpayer ID, Name, Email Address), add store(s), enter purchase detail, sales markup percentage, and sales price into the application (see Figure II for illustration). As also shown in Figure II, the taxpayer may also upload invoices relating to the transactions, and such invoices will be stored for the statute of limitations period to assist taxpayer with its recordkeeping and in the event of an audit.

The application connects to the database using a SQL Server and taxability is determined based upon the database. The database name is “convenienceStore”. The database consists of product categories (i.e. Auto products, Bank Charges, Building Security, etc.) and within each product category is a list of products (i.e. Auto products category includes gasoline, inspection, maintenance, etc.). Taxability is assigned at a product category level. SALTware LLC may manage the products as illustrated in Figure VI.

The integral component of the application is a repository of products and expenses that are taxable and non-taxable. This repository is consumed by the logic used to produce the tax reports. Therefore, the ease of maintaining products, expenses, and their taxability is critical to the success of complete, accurate and efficient tax reporting.

In the event a product input by the taxpayer is not identified by the database, the application sends an email to the administrator. The administrator can review the product, determine taxability and update the database accordingly.

To generate a report of taxability determinations, taxpayer need only checkout as shown in number 5 and 6 of Figure X.

The following is an overview of the application architecture.

A. Application Architecture
a. The coding language is ASP.NET (C# .NET on .Net 4.0 Framework).
b. Database: SQL Server 2005
c. Database Server: Windows 2003
d. Database Server Internal IP: 172.21.2.7 (Server Name: Server2650-new)
e. Web Server: Windows 2008 (IIS 6)
f. Web Server Internal IP: 172.21.2.8 (Server Name: web01)
g. Web Server IP: 99.18.164.244
h. Hosting Providers: n/a. However, PayPal is used for processing payments

B. Presentation.
a. HTML: There is very limited HTML written in the application in the traditional manner. HTML is generated via one long string in the code behind file and then written to http context response. The application does use an ASP.Net master page named “convenienceStore.master”. Content holders on the master page are loaded with HTML within each of the .aspx files.
b. CSSL: There is only one CSS file name “convenienceStore.css”. This file contains styling for every page combined. The CSS file is linked to all pages via the sole master page named “convenienceStore.master”. The CSS file is not minified.
c. JavaScript: JavaScript is lightly used on the pages. The two primary uses are for input validation and AJAX calls for auto-completion of city, county, and tax. JavaScript is not externally referenced, is limited with Object Oriented Programming (OOP, and is not minified.

C. Business Logic
a. JavaScript: Client side scripting is limited
b. C#.NET: The coding technique is primarily procedural (i.e., there is limited use of OOP). The Data Access Layer (DAL) is tightly coupled and ADO.NET calls using the System.Data.SQLClient.SQLConnection class are on every page where database commands are required. Inline SQL is used for all database commands. There are no factory patterns but there are some helper/utility classes regarding input checking, creating tabs, and generating navigation. Configurations (e.g., database connection string, email server, default tax rates, etc.) are stored in text files within the site directory. There are classes that read these configurations and provide the settings noted throughout the applications. For example, the sqlSource class opens the text file sqlSource.txt, gets the noted connection string listed in the text file, and provides the connection string for ADO.Net calls via the method getSqlSource( ) throughout the application. As for state maintenance, there is limited use of caching but session state is used to store whether or not the user is an Admin. There appears to only be two roles/privileges which are Admin or Client. Users login on the page, Login.aspx, where it is determined whether the user is an admin or client and then stored in the session. The application uses impersonation and runs under the Domain Controller Admin account renamed “Master”.

D. Data Access Layer: ADO.NET is used to access the database. The site stores connection strings in the text files located in the database directory (which uses integrated security). The application connects to the database (convenienceStore) using the SQL Server sa account.

E. Data (SQL Server): Table entity relationships appear to be in 2nd Normal form in a SQL Server 2005 database. The database name is “convenience Store”. There are no stored procedures, functions or triggers. There are several views created to retrieve data more efficiently.

F. Security
a. Server: The server is not patched on a regular schedule. A Business Class DSL connection is used to connect to the web server. The web server and database server are running on the “danmartinez” domain and not running on a DMZ.
b. Website: IIS runs under the IIS anonymous user and is configured to use Windows Integrated Authentication. The use of Windows Integrated Authentication is unknown. Accessing the regular site (i.e., presentation of content) runs under the account danmartinez/master via impersonation set within the web.config. There are only two roles/privileges which are Client and Admin. If you are Admin, you can view everything and if you are client, then you can load sales, load expenses, and then view/purchase reports.
c. Database: The application only has one database and the connection to the database from the application uses the SQL server sa account.

1. The invention claimed is a web-based software application to be used by tax professionals to determine taxability of 100% of its client's purchases during a reporting period (or soon thereafter), minimizing or eliminating the costly tax exposure direct permit holders currently experience. The software operates as follows:
the tax professional's client data is provided in MS Access database format and is imported into the present invention;
the tax professional's client data is transformed to support program taxability analysis (i.e. a schema is created);
the data is then assessed as taxable, non-taxable, not-applicable, etc. and taxability rules that apply Boolean if-then logic are created relevant to the client (i.e. “If VENDOR NAME equals “Green Energy,” then set to Exempt”);
created taxability rules are saved and can be re-used to assess same or related client's future data;
assessed Client data is reported on to show new taxability assignment versus the original assignment made by the client;
automated sampling of the client data to be reviewed for accuracy of the taxability assignments; and
advanced reporting to the client on its data (i.e. data may be queried and then viewed) for analysis and client presentation.
